(19) United States
(12) Patent Application Publication
(10) Pub. No.: US 2024/0265483 A1
(43) Pub. Date: Aug. 8, 2024

(54) METHODS AND INTERNET OF THINGS SYSTEMS FOR GOVERNMENT SAFETY SUPERVISION OF SMART GAS INFORMATION

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yaqiang QUAN, Chengdu (CN); Guanghua HUANG, Chengdu (CN); Yongzeng LIANG, Chengdu (CN)

(73) Assignee: CHENGDU QINCHUAN IOT TECHNOLOGY CO., LTD., Chengdu (CN)

(21) Appl. No.: 18/624,026

(22) Filed: Apr. 1, 2024

(30) Foreign Application Priority Data
Mar. 4, 2024 (CN) 202410239178.5

(51) Int. Cl. G06Q 50/26

(52) U.S. Cl. CPC G06Q 50/265

(57) ABSTRACT

The present disclosure provides a method and a system for government safety supervision of smart gas information. The method may include: obtaining gas supervision data; determining a division result; determining verification data based on the gas supervision data and the division result and receiving a verification result; determining a preset supervision level based on the verification result; determining a collection volume and a collection frequency for candidate gas supervision data based on the preset supervision level; and obtaining a feedback result and generating a level adjustment instruction and a collection update instruction. The system may include a government safety supervision management platform, a government safety supervision sensing network platform, a government safety supervision object platform, a gas company sensing network platform, a gas device object platform, and a gas user object platform. The government safety supervision object platform may include a gas company management platform.

### CROSS-REFERENCE TO RELATED APPLICATIONS

This application claims priority to Chinese Patent Application No. CN202410239178.5, filed on Mar. 4, 2024, the entire contents of which are hereby incorporated by reference.

### TECHNICAL FIELD

The present disclosure relates to a field of Internet of Things (IoT), and in particular to a method and an Internet of Things (IoT) system for government safety supervision of smart gas information.

### BACKGROUND

Gas, as a clean energy source, not only brings convenience to people's production and daily life, but its flammable and explosive characteristics are closely related to the safety of public property and the lives of millions of households. Relevant systems of gas operation involve a large count of gas users and gas facilities. At present, most of basic information sources for competent government safety supervision departments, such as various types of gas companies and key gas-using enterprises, are statistically managed in the form of paper reports or manually filled reports, which has a low level of informatization, incomplete and untimely information acquisition, and low efficiency in feedback mechanisms, resulting in significant compromises in the timeliness and intensity of the competent government safety supervision departments. As gas is increasingly used in residential and commercial sectors, gas safety accidents occur from time to time. How to efficiently and informatively supervise the relevant systems of gas operation with limited human resources has become an urgent issue for the competent government safety supervision departments.

Therefore, it is desirable to provide a method and an IoT system for government safety supervision of smart gas information to collect and analyze gas monitoring data intelligently, which can improve the reliability of supervision, and ensure the effectiveness of the management of gas supervision data in the case of limited human resources, thereby meeting requirements of the competent government safety supervision departments.

### SUMMARY

One or more embodiments of the present disclosure provide a method for government safety supervision of smart gas information. The method may include: obtaining gas supervision data from a gas device object platform and/or a gas user object platform based on a gas company sensing network platform, wherein the gas supervision data includes an occurrence time, a data source, and a data content, and the gas company sensing network platform transmits the gas supervision data at a preset transmission rate based on a communication device; determining a division result based on the gas supervision data; determining verification data based on the gas supervision data and the division result, sending the verification data to a government safety supervision management platform based on a government safety supervision sensing network platform, and receiving a verification result feedbacked from the government safety supervision management platform; determining a preset supervision level for the gas device object platform and/or the gas user object platform based on the verification result and determining a collection volume and a collection frequency for candidate gas supervision data based on the preset supervision level; and obtaining a feedback result and generating a level adjustment instruction and a collection update instruction from the government safety supervision management platform based on the government safety supervision sensing network platform, wherein the feedback result is determined based on the verification data and the verification result, the level adjustment instruction and the collection update instruction are generated based on the feedback result, the level adjustment instruction is configured for an adjustment of the preset supervision level, and the collection update instruction is configured for an update of the collection volume.

One or more embodiments of the present disclosure provide an Internet of things (IoT) system for government safety supervision of smart gas information, which may include a government safety supervision management platform, a government safety supervision sensing network platform, a government safety supervision object platform, a gas company sensing network platform, a gas device object platform, and a gas user object platform. The government safety supervision object platform may include a gas company management platform which may be configured to: obtain gas supervision data from a gas device object platform and/or a gas user object platform based on a gas company sensing network platform, wherein the gas supervision data may include an occurrence time, a data source, and a data content, and the gas company sensing network platform may transmit the gas supervision data at a preset transmission rate based on a communication device; determine a division result based on the gas supervision data; determine verification data based on the gas supervision data and the division result, send the verification data to a government safety supervision management platform based on the government safety supervision sensing network platform, and receive a verification result feedbacked from the government safety supervision management platform; determine a preset supervision level for the gas device object platform and/or the gas user object platform based on the verification result and determine a collection volume and a collection frequency for candidate gas supervision data based on the preset supervision level; and obtain a feedback result and generate a level adjustment instruction and a collection update instruction from the government safety supervision management platform based on the government safety supervision sensing network platform, wherein the feedback result may be determined based on the verification data and the verification result, the level adjustment instruction and the collection update instruction may be generated based on the feedback result, the level adjustment instruction may be configured for an adjustment of the preset supervision level, and the collection update instruction may be configured for an update of the collection volume.

One or more embodiments of the present disclosure provide a non-transitory computer-readable storage medium storing one or more set of computer instructions. When reading the one or more set of computer instructions in the storage medium, a computer may implement the above method for government safety supervision of the smart gas information.

Beneficial effects of the present disclosure may include but are not limited to: through the method for government safety supervision of the smart gas information, the analysis and smart verification of gas supervision data, as well as the determination of corresponding supervision intensity and data collection requirements can be achieved. The method can significantly save human and material resources, effectively manage the gas supervision data, dynamically adjust the supervision intensity of the IoT system for government safety supervision of the smart gas information based on the gas supervision data, enhance the reliability of supervision, ensures the effectiveness of gas supervision data management, meet the requirements of government safety supervision departments, and prevent gas accidents.

### BRIEF DESCRIPTION OF THE DRAWINGS

The present disclosure will be further illustrated by way of exemplary embodiments, which will be described in detail with reference to the accompanying drawings. These embodiments are not limiting. In these embodiments, the same numbering indicates the same structure, wherein:

FIG. 1 is a schematic diagram illustrating an Internet of things (IoT) system for government safety supervision of smart gas information according to some embodiments of the present disclosure;

FIG. 2 is a flowchart illustrating an exemplary process for government safety supervision of smart gas information as according to some embodiments of the present disclosure;

FIG. 3 is a flowchart illustrating an exemplary process of determining a grade division result as according to some embodiments of the present disclosure; and

FIG. 4 is a schematic diagram illustrating an exemplary grading model according to some embodiments of the present disclosure.

### DETAILED DESCRIPTION

In order to further illustrate the technical solutions of the embodiments of the present disclosure, a brief introduction will be made to the drawings required for the description of the embodiments. It is obvious that the drawings described below are only examples or embodiments of the present disclosure. For those skilled in the art, without exercising inventive labor, the present disclosure may also be applied to other similar scenarios based on these drawings. Unless otherwise indicated or specified from the context, identical reference numerals in the drawings represent identical structures or operations.

Flowcharts are used in the present disclosure to illustrate operations performed by the system in accordance with the embodiments of the present disclosure. It should be understood that the preceding or following operations are not necessarily performed in an exact sequence. Instead, the operations may be processed in reverse order or simultaneously. Also, it is possible to add other operations to these processes or remove an operation or operations from these processes.

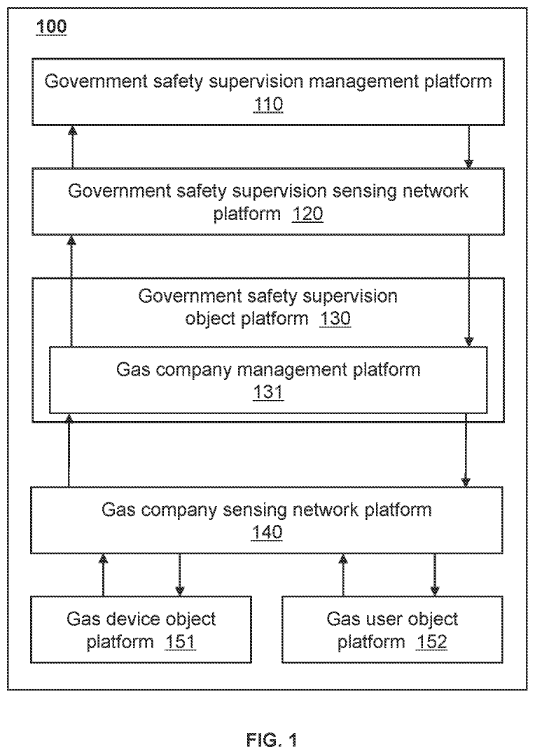

FIG. 1 is a schematic structural diagram of an Internet of things (IoT) system for government safety supervision of smart gas information according to some embodiments of the present disclosure.

In some embodiments, as shown in FIG. 1, an Internet of things (IoT) system 100 for government safety supervision of smart gas information may include a government safety supervision management platform 110, a government safety supervision sensing network platform 120, a government safety supervision object platform 130, a gas company sensing network platform 140, a gas device object platform 151, and a gas user object platform 152.

The government safety supervision management platform 110 refers to a comprehensive management platform for a government to conduct safety management.

The government safety supervision management platform 110 (hereinafter referred to as the government safety management platform) may interact with the government safety supervision sensing network platform 120 (hereinafter referred to as the government safety sensing platform). For example, the government safety management platform may receive verification data and a corresponding verification result uploaded by the gas company management platform 131 (hereinafter referred to as the company management platform) through the government safety sensing platform, and send a feedback result to the company management platform through the government safety sensing platform. In some embodiments, the government safety management platform may determine the feedback result and generate a level adjustment instruction and a collection update instruction. In some embodiments, the government safety supervision management platform 110 may be configured on at least one set of servers and configured to cache the verification data and check the verification data in a sorting sequence.

The government safety sensing platform refers to a platform used for comprehensive management of government sensing information. For example, the government safety sensing platform may include a communication base station, a router, a wireless WIFI device, or the like. The government safety sensing platform may interact with the government safety management platform and the company management platform.

The government safety supervision object platform 130 refers to a platform for the generation of government supervision information and the execution of control information.

In some embodiments, the government safety supervision object platform 130 may include the gas company management platform 131.

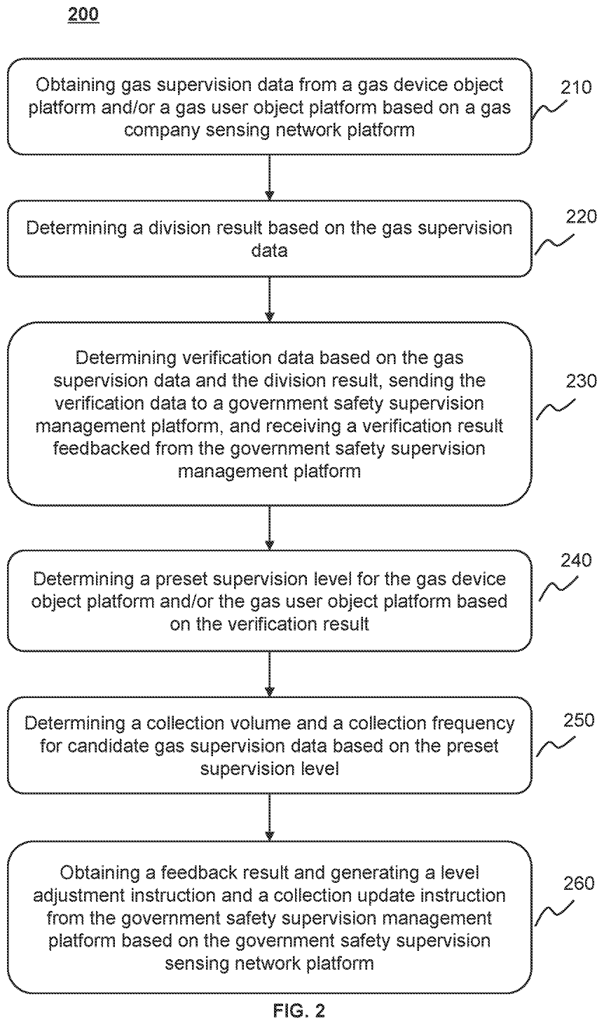

In some embodiments, more descriptions of the company management platform may be found in the related descriptions of FIG. 2 to FIG. 4.

The gas company sensing network platform 140 (hereinafter referred to as the company sensing platform) refers to a platform for the comprehensive management of sensor information of a gas company. For example, the company sensing platform may include a communication base station, a router, a wireless WIFI device, or the like. The company sensing platform may interact with the company management platform, the gas device object platform 151, and the gas user object platform 152.

In some embodiments, the company sensing platform may include different sensing network sub-platforms. The different sensing network sub-platforms correspond to different types of communication devices located in different regions. The company sensing platform may transmit gas supervision data at a preset transmission rate based on the communication devices.

The gas device object platform 151 refers to a functional platform for the generation of gas sensing information and the execution of control information. The gas device object platform may be configured in a gas facility (e.g., a gas gate station, a gas field station, a gas regulator station, a valve shaft, a filling station, a gas users' household, etc.) or in an affiliated facility of a gas pipeline network.

In some embodiments, the gas device object platform may interact with the company management platform via the company sensing platform. For example, the company management platform may obtain the gas supervision data from the gas device object platform based on the company sensing platform and send the adjustment instruction and/or the collection update instruction to the gas device object platform.

The gas user object platform 152 refers to a platform for collecting information about a gas user. For example, the gas user object platform may obtain information on a gas usage characteristic, a gas usage environment, gas usage safety knowledge of the gas user, or the like. The gas user object platform may be configured in a terminal of gas operation and maintenance personnel and/or the gas user.

The gas user object platform 152 may interact with the company management platform via the company sensing platform. For example, the company management platform may obtain the gas supervision data from the gas user object platform based on the company sensing platform and send the adjustment instruction and/or the collection update instruction to the gas user object platform, or the like.

Based on the IoT system for government safety supervision of the smart gas information, a closed loop of information operation can be formed between the various functional platforms, enabling coordinated and regulated operations, thus achieving information-based and intelligent gas information supervision.

FIG. 2 is a flowchart of an exemplary process for government safety supervision of smart gas information according to some embodiments of the present disclosure. As shown in FIG. 2, a process 200 includes following operations.

In 210, gas supervision data may be obtained from a gas device object platform and/or a gas user object platform based on a gas company sensing network platform.

More descriptions of the platforms may be found in FIG. 1 and the related descriptions thereof.

The gas supervision data refers to data related to gas safety supervision. The gas supervision data may include at least one of pipeline operation safety information, gas usage safety information, safety assessment information, or the like.

In some embodiments, the gas supervision data may include at least one of an occurrence time, a data source, and a data content.

The occurrence time refers to a time point when the gas supervision data is obtained.

The data source refers to a source from which the gas supervision data is obtained. The data source may include a region and a device from which the gas supervision data is obtained. For example, the data source of the gas supervision data may be a preset gas supervision region and/or a corresponding gas device object platform and/or gas user object platform, or the like.

In some embodiments, a company management platform may determine the data source by querying a communication device that transmits the gas supervision data via a company sensing platform. The communication device may be of various types, for example, the communication device may include a router, a switch, or the like.

The company management platform may determine the gas supervision region in which the communication device is located and the corresponding gas device object platform and/or gas user object platform by querying information of the communication device that transmits the gas supervision data, thereby determining the data source.

In some embodiments, gas supervision data from different gas supervision regions and/or corresponding gas device object platforms and/or gas user object platforms may be differentially data-identified in advance according to a preset process. The company management platform may determine the corresponding data source of the gas supervision data by the data identification of the gas supervision data.

The data content refers to information contained in the gas supervision data. The data content may include quantitative data and qualitative data. The quantitative data may include a gas flow rate, or the like. The quantitative data may be obtained based on a gas supervision device. The qualitative data may include a gas failure and a failure type, gas abnormal data, a scope of impact of maintenance urgency, or the like. The gas abnormal data may include the gas flow rate exceeding a preset threshold, or the like. The qualitative data may be uploaded and obtained based on the gas device object platform and/or the gas user object platform.

In some embodiments, the company management platform may obtain the gas supervision data based on platform interactions in various ways. For example, the occurrence time may be obtained based on the time recorded by the gas device object platform, each time the gas supervision data is collected by the gas supervision device. The data source may be obtained based on information from the communication device stored by the gas device object platform. The data content may be obtained based on the gas user object platform, through user input, or the like.

In some embodiments, the company sensing platform may transmit the gas supervision data at a preset transmission rate based on the communication device. The preset transmission rate is a preset rate at which data is transmitted, which may be preset based on prior experience.

The company management platform may receive the gas supervision data from the company sensing platform.

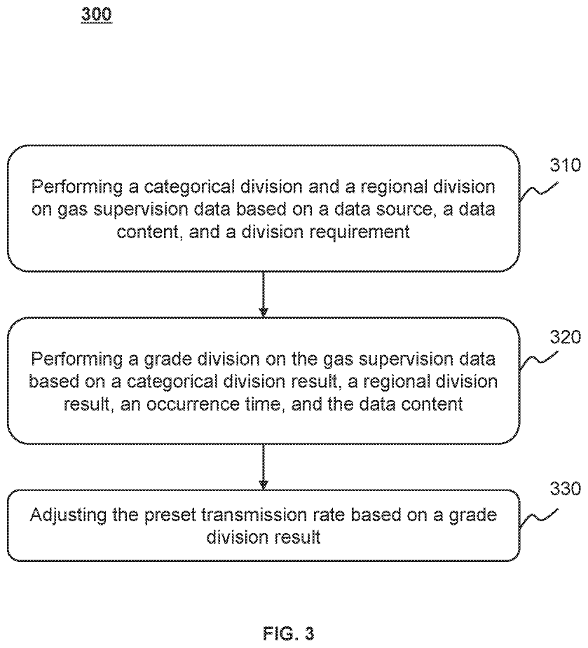

In some embodiments, the company management platform may perform a grade division on the gas supervision data based on a categorical division result of the gas supervision data, a regional division result, the occurrence time, and the data content. The company management platform may adjust the preset transmission rate based on the grade division result. More descriptions of adjusting the preset transmission rate may be found in FIG. 3 and related descriptions thereof.

In 220, a division result may be determined based on the gas supervision data.

The division result is a result obtained after the gas supervision data is categorized. In some embodiments, the company management platform may determine the division result of the gas supervision data based on the occurrence time, the data source, and the data content of the gas supervision data through automatic division.

The automatic division refers to an operation in which the company management platform categorizes the gas supervision data. In some embodiments, the company management platform may categorize the gas supervision data in accordance with a preset division rule. The preset division rule may include at least one of a grade division, a categorical division, a regional division, or the like. The division result may include a grade division result, a categorical division result, and a regional division result. The above division results are obtained via the grade division, the categorical division, and the regional division, respectively.

The grade division refers to a division of the gas supervision data into different levels according to a first preset rule. The first preset rule refers to a criterion for the grade division of the gas supervision data. For example, the first preset rule may include a severity level and scope of impact of a risk that the gas supervision data may cause, an importance of the gas supervision data, or the like. The severity level and scope of impact of the risk that the gas supervision data may cause and the importance of the gas supervision data may be determined based on historical data or prior experience. For example, the grade division may be a division of the gas supervision data into five levels according to the importance of the gas supervision data, which may be expressed as a number, with a smaller number indicating more important gas supervision data.

The categorical division refers to a division of the gas supervision data into different types. The different types may include gas pipeline network related data, gas gate station related data, gas installation related data, gas operation related data, or the like. The company management platform may obtain the above data from the gas device object platform and/or the gas user object platform via the company sensing platform. In some embodiments, the company management platform may determine the categorical division result by querying a first preset table based on the above data. The first preset table may include a correspondence between the above data and the categorical division result. The first preset table may be determined based on historical data or prior experience.

The regional division refers to a division of the gas supervision data into different gas supervision regions. The count of gas supervision regions may be more than one. The gas supervision regions may be different neighborhoods, blocks, or the like. In some embodiments, the company management platform may determine, based on the data source of the gas supervision data, the gas supervision region corresponding to the communication device transmitting the gas supervision data, and designate the gas supervision region as the gas supervision data corresponding to the regional division result.

More descriptions of the grade division, the categorical division, and the regional division may be found in FIG. 3 and the related descriptions thereof.

In 230, verification data may be determined based on the gas supervision data and the division result, the verification data may be sent to a government safety supervision management platform, and a verification result feedbacked from the government safety supervision management platform may be received.

The verification data is gas supervision data that requires further detailed analysis. For example, the verification data may be gas supervision data that cannot be determined whether it may have an adverse impact, gas supervision data that requires further determination of maintenance urgency, or gas supervision data that requires further determination of the scope of the impact.

In some embodiments, the verification data may be determined in various ways. For example, the company management platform may determine the verification data by querying a second preset table based on the division result of the gas supervision data. The second preset table may include a correspondence between the severity levels of the risks corresponding to different division results of the gas supervision data and the verification data. The second preset table may be determined based on historical data or prior experience.

The severity levels of the risks corresponding to regional division results may be determined based on a third preset table. The third preset table may include a correspondence between data volumes corresponding to the regional division results and the severity levels of the risks. The third preset table may be determined based on historical data or prior experience. The data volume corresponding to the regional division result refers to the volume of verification data in the gas supervision region corresponding to the division result in the historical data.

The verification result refers to a result of further analysis of the verification data. The verification result may include feedback on the verification data (whether the maintenance urgency, the scope of impact are accurate, whether they are more serious), etc., and at least one of corresponding data volume, data type, and the gas supervision region to which the verification data belongs.

In some embodiments, the company management platform may receive the verification result feedbacked from the government safety supervision management platform via the government safety supervision sensing network platform. The government safety supervision management platform may determine the verification result in a variety of ways. For example, the government safety supervision management platform may determine the verification result via staff feedback on the verification data, via the communication device transmitting the verification data, or the like.

In some embodiments, the company management platform may determine the verification data based on a dynamic grading result of the gas supervision data and relevant facility data and determine a sorting sequence based on the verification data.

The dynamic grading result refers to a sequence of grade division results corresponding to the gas supervision data for a plurality of sub-time periods within a preset time period. In some embodiments, the preset time period may be evenly divided into a plurality of sub-time periods, and the grade division result corresponding to the gas supervision data of each sub-time period may form the dynamic grading result.

The relevant facility data refers to data related to other public facilities. Other public facilities may include electricity, water, public transportation, heating facilities, or the like. Since other public facilities may affect facilities related to gas, the related facility data of other public facilities needs to be considered. The relevant facility data may include failure data, operation data, maintenance data of the other public facilities, or the like.

In some embodiments, different gas supervision regions may correspond to different relevant facility data. The relevant facility data may reflect a situation of facilities related to the corresponding gas supervision region.

In some embodiments, the relevant facility data may be obtained via a government safety management platform. The company management platform may obtain the relevant facility data obtained by the government safety management platform via a government safety sensing platform.

In some embodiments, the government safety management platform may also interact with a third-party platform to obtain the relevant facility data. The relevant facility data (whether or not a malfunction has occurred, etc.) is beneficial to staff in the field in determining whether other facilities affect a gas pipeline, interfering with gas delivery, or the like.

In some embodiments, the company management platform may determine the verification data in various ways. For example, the company management platform may determine the verification data based on the dynamic grading result of the gas supervision data and the relevant facility data corresponding to different gas supervision regions. The company management platform may determine the gas supervision data that satisfies at least one preset verification condition as the verification data.

A preset verification condition refers to a condition that needs to be met by the corresponding dynamic grading result and the relevant facility data when the gas supervision data is determined as the verification data. The preset verification condition may include a count of times the dynamic grading result exceeds a preset grading threshold reaching a preset frequency threshold, a degree of impact of the relevant facility data on the gas supervision data exceeding a preset impact threshold, etc.

The preset grading threshold is a maximum value of the level of the gas supervision data in the preset grade division result so that the gas supervision data is determined as the verification data. The preset frequency threshold is the minimum count of times the preset dynamic grading result needs to meet the preset grading threshold so that the gas supervision data is determined as the verification data.

In some embodiments, the company management platform may annotate the degree of impact of the relevant facilities corresponding to different gas supervision regions on the gas supervision data through staff or a preset rule. The preset impact threshold may be determined based on historical data or prior experience. By way of example, the preset rule may be that if there is a failure in other public facilities within a gas supervision region, and the impact within the gas supervision region exceeds the preset impact threshold.

The sorting sequence is a result of sorting the verification data in descending order of priority.

In some embodiments, the company management platform may determine the sorting sequence in various ways. For example, the company management platform may determine the sorting sequence based on a region size of the regional division corresponding to the verification data and the dynamic grading result. More descriptions of the region size of the regional division corresponding to the verification data may be found in FIG. 3. The region size is negatively correlated with the priority, the smaller the region size, the higher the priority, and thus the corresponding verification data is placed higher in the sorting sequence. The higher the level of the dynamic grading result is, the smaller the region size is, and the higher the priority is.

In some embodiments, the company management platform may determine the priority of the verification data and the sorting sequence by determining a ranking score. The ranking score may characterize the priority of the verification data, and the higher the ranking score, the higher the priority of the verification data, and the higher the verification data is placed in the sorting sequence. For example, the company management platform may determine the ranking score based on a scale score and a dynamic grading result score.

The scale score is a quantified value of the region size. The company management platform may query a fourth preset table to determine the scale score based on the region size of the regional division result corresponding to the verification data. The fourth preset table includes a correspondence between the region size of the regional division result corresponding to the verification data and the scale score. The fourth preset table may be determined based on historical data and prior experience. The region size is negatively correlated with the scale score. The scale score is positively correlated with the ranking score.

The dynamic grading result score is a quantified value of the dynamic grading result. The dynamic grading result score is negatively correlated with the dynamic grading result. For example, the dynamic grading result score may be the inverse of an average of all grade division results in the dynamic grading result after the gas supervision data is determined as the verification data for the first time. The dynamic grading result score is positively correlated with the ranking score.

For example, the company management platform may determine the ranking score by using the following formula (1):

$$α = {μ}_{1} \times A + {μ}_{2} \times B \qquad ( 1 )$$

Wherein α denotes the ranking score of the verification data, A denotes the scale score, μ₁ denotes a weight corresponding to a scale, B denotes the dynamic grading result score, and μ₂ denotes a weight corresponding to the dynamic grading result. μ₁ and μ₂ may be preset manually.

Since the dynamic grading result includes multiple grade division results within the preset time period, if a subsequent grade division result corresponding to the verification data decrease, the sorting score corresponding to the verification data may be affected and decreased, resulting in the verification data being moved later in the sorting sequence.

In some embodiments, in response to determining that the dynamic grading result meets a preset adjustment condition, the company management platform may adjust the sorting sequence.

The preset adjustment condition refers to a condition that needs to be met by the dynamic grading result when adjustments are made to the sorting sequence. The preset adjustment condition may include that a difference between two consecutive grade division results of the verification data is not less than a difference threshold. The difference threshold is the maximum value of acceptable differences between two consecutive grade division results and may be preset manually.

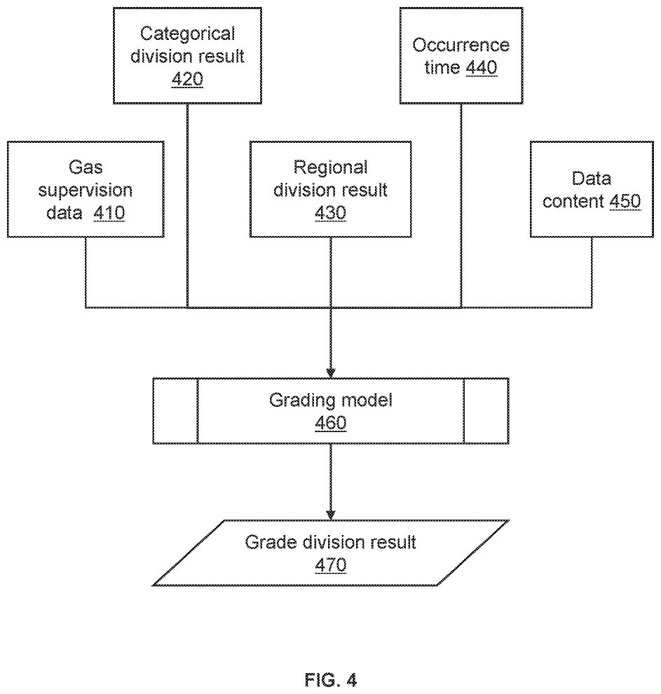

In some embodiments, the company management platform may determine a key supervision region based on an abnormal frequency and determine the grade division result for the key supervision region using a grading model, thereby determining the dynamic grading result. In response to determining that the dynamic grading result meets the preset adjustment condition, the company management platform may adjust the sorting sequence. The dynamic grading result may include a sequence consisting of grade division results obtained each time the grading model is activated. More descriptions of the abnormal frequency, the key supervision region, and the grading model, etc., may be found in FIG. 3 and FIG. 4 and the related descriptions thereof. For example, when the difference threshold is level 2 and the grading model is activate every 2 hours for grading the key supervision region, if two consecutive grade division results are level 2 and level 4 respectively, the difference between the two grade division result is 2 levels. If the two consecutive grade division results satisfy the preset adjustment condition, the company management platform may determine a new ranking score corresponding to the verification data based on a second grade division result, leading to a decrease in the corresponding sorting score and a shift to a later position in the sorting sequence. If the new sorting order exceeds the maximum sequence number in the sorting sequence, it is considered that the verification data poses no risk and further verification may not be necessary.

Considering the fluctuation of the gas supervision data over time and in response to the dynamic grading result meeting the preset adjustment condition, the company management platform may dynamically adjust the sorting sequence of the verification data to avoid excessive use of computing resources by redundant data, enhance verification efficiency, and facilitate timely identification and mitigation of gas risks.

In some embodiments, the company management platform may also send the verification data and the sorting sequence to the government safety supervision management platform.

Based on the dynamic grading result of the gas supervision data and the relevant facility data, the company management platform can determine the verification data. This approach takes into account the impact of the dynamic changes of the gas supervision data over time and the impact of other public facilities on the gas supervision data, improving the accuracy of the verification data. In addition, the company management platform can determine the sorting sequence based on the verification data and present the priority of the verification data through the sorting sequence. The service platforms can process the verification data in priority order, thus enhancing verification efficiency and effectively mitigating gas risks.

In 240, a preset supervision level for the gas device object platform and/or the gas user object platform may be determined based on the verification result.

The preset supervision level is predetermined level for the gas device object platform and/or the gas user object platform. The preset supervision level may characterize a workload of the gas device object platform and/or the gas user object platform. The higher the preset supervision level is, the higher the workload corresponding to the object platform. For example, a higher preset supervision level may indicate a need for collecting more data and uploading data more frequently.

In some embodiments, the preset supervision level may include an operational safety level and an operational reliability level. The operational safety level and the operational reliability level may characterize the importance of the associated object platform with respect to safety supervision and supervision regulation respectively.

In some embodiments, the gas device object platform and/or the gas user object platform is required to perform data collection, data uploading, or the like at a future time according to the preset supervision level.

In some embodiments, the company management platform may determine the preset supervision level based on the verification result in various ways. For example, the company management platform may determine risk levels of verification results corresponding to different gas device object platforms and/or gas user object platforms. In response to determining the risk level in the verification result satisfies a preset supervision condition, the company management platform may determine the preset supervision levels corresponding to the different gas device object platforms and/or gas user object platforms by analyzing a proportion of verification results meeting the preset supervision condition to a total verification result for each platform, through querying a fifth preset table.

A risk level in a verification result may characterize an extent to which the verification result represents a potentially greater severity of gas risk compared to the corresponding verification data.

The preset supervision condition refers to a condition that needs to be met if the verification result is determined to be undesirable. The preset supervision condition may include the risk (maintenance urgency, scope of impact, etc.) level of the verification result being higher than the predicted risk (maintenance urgency, scope of impact, etc.) of the verification data.

The fifth preset table may include the correspondence between the percentage of verification results whose risk levels meet the preset supervision condition and the preset supervision level. The fifth preset table may be determined based on historical data and prior experience.

In some embodiments, the company management platform may determine the preset supervision level based on the verification result and a historical supervision level.

More descriptions of the verification data may be found in the related descriptions above.

The historical supervision level refers to a supervision level used by the gas device object platform and/or the gas user object platform. In some embodiments, the historical supervision level may be a preset supervision level that was used at a historical time or is in use at a current time. A higher historical supervision level indicates a stricter level of supervision.

In some embodiments, the company management platform may determine the historical supervision level by querying a sixth preset table based on historical gas supervision data and historical verification data. The historical gas supervision data refers to gas supervision data collected in the past. The historical verification data refers to verification data recorded in the past. The sixth preset table may be preset to store correspondences of the historical supervision level with the historical gas supervision data and the historical verification data. The sixth preset table may be determined based on historical data or prior experience.

In some embodiments, the company management platform may determine the preset supervision level based on the verification result and the historical supervision level in various ways. If the verification result is unsatisfactory, the company management platform may adjust the historical supervision level upward by one level as the preset supervision level. The verification result being unsatisfactory means that the verification result identifies a risk level that is greater than the predicted risk of the verification data.

In some embodiments, the company management platform may determine the preset supervision level of the corresponding gas device object platform and/or gas user object platform based on weighted data of the dynamic grading result. More descriptions of the dynamic grading result may be found in the related description above.

In some embodiments, the gas device object platform may correspond to at least one set of gas supervision data for at least one gas supervision region, and the company management platform may determine a weighted value for the at least one set of gas supervision data in accordance with the categorical division result, the grade division result, or the like, and adjust the corresponding preset supervision level based on the weighted value.

In some embodiments, a large amount of gas supervision data of the gas device object platform corresponds to multiple historical supervision levels that are grade-divided sequentially at a plurality of time points, and the company management platform may determine, through a weighted processing, the preset supervision level corresponding to the gas device object platform.

The weighted data refers to a weighted value of the dynamic grading result of the at least one set of gas supervision data for the at least one gas supervision region corresponding to the gas device object platform or the gas user object platform in a preset time period. More descriptions of the dynamic grading result may be found in the related descriptions above. In some embodiments, the company management platform may weight a plurality of sets of historical verification data of the gas device object platform or the gas user object platform to determine the weighted data corresponding to that gas device object platform or gas user object platform. For example, the weighted data may be calculated by the following formula:

$$N = {a}_{1} {L}_{1} + {a}_{2} {L}_{2} + … + {a}_{n} {L}_{n} \qquad ( 2 )$$

Where N denotes the weighted data, Lₙ denotes the weighted grading value of the n-th historical verification data, and a₁, a₂, . . . , and aₙ denote weights.

In some embodiments, the company management platform may weigh the multiple grading results of the historical verification data in the preset time period and calculate to obtain a weighted grading value of the historical verification data. For example, the weighted grading value of the historical verification data may be calculated using the following formula:

$$L = {b}_{1} {l}_{1} + {b}_{2} {l}_{2} + … + {b}_{m} {l}_{m} \qquad ( 3 )$$

Wherein L denotes the weighted grading value of the historical verification data, Iₘ denotes the m-th grading of the historical verification data, and b₁, b₂, . . . , and bₘ denote weights. The company management platform may determine a time interval between a time of grading the historical inspection data and a current time. The smaller the time interval is, the larger the weight b is.

In some embodiments, the company management platform may determine the weighted grading value corresponding to each of n sets of historical verification data, respectively using formula (3).

In some embodiments, the company management platform may conduct a search in a weight vector database based on a verification data vector to determine the weights a₁, a₂, . . . , and aₙ. The verification data vector is used to characterize the region size to which the historical verification data belongs, the data type of the historical verification data, etc., wherein elements of the verification data vector may include the region size to which the historical verification data belongs and the data type of the verification data vector. In some embodiments, the company management platform may determine the region size to which the historical verification data belongs and the data type of the verification data vector based on the regional division result and the categorical division result, respectively. More descriptions of the regional division result and the categorical division result may be found in related descriptions of FIG. 2.

The weight vector database is constructed based on historical data, Internet data, etc., and includes at least one reference data vector and weight(s) corresponding to the at least one reference data vector. The reference data vector is constructed based on the historical dynamic grading result, wherein elements of the reference data vector may include the region size to which the historical verification data corresponding to the historical dynamic grading result belongs and the data type of the historical verification data.

The company management platform may search in the weight vector database based on the verification data vector, take reference data vector that is most similar to the verification data vector as a target vector, and determine the weight a corresponding to the current historical verification data based on the reference weight corresponding to the target vector.

In some embodiments, the company management platform may determine, based on weighted data, the preset supervision level of the corresponding gas device object platform and/or the gas user object platform in various ways. The company management platform may determine the preset supervision level by querying a seventh preset table based on the weighted data. The seventh preset table includes a correspondence between the preset supervision level and the weighted data. The seventh preset table may be determined based on historical data or prior experience. For example, the company management platform may determine the preset supervision level based on a magnitude of the weighted data in relation to a preset weighting threshold, as well as the historical supervision level. For example, when the weighted data exceeds the preset weighting threshold, the preset supervision level is 1 level higher than the historical supervision level; when the weighted data is below the preset weighting threshold, the preset supervision level is 1 level lower than the historical supervision level. The preset weighting threshold may be set manually or automatically.

The company management platform may determine the preset supervision level based on the weighted data of the dynamic grading result, enabling the preset supervision levels of different gas device object platforms to be determined or adjusted in advance based on the verification result. By establishing data collection strategies before conducting data analysis, the quality of data analysis can be enhanced.

The company management platform may supervise different object platforms with different supervision levels and adjusts a collection volume based on the preset supervision levels, which can effectively improve supervision efficiency and avoid generating a large amount of low-impact supervision data that consume computing resources of the platform.

In 250, a collection volume and a collection frequency for candidate gas supervision data may be determined based on the preset supervision level.

The candidate gas supervision data refers to gas data that may be uploaded. Gas supervision data consists of a portion of the candidate gas supervision data.

In some embodiments, the candidate gas supervision data may include data collected by the gas device object platform and the gas user object platform, as well as gas-related data stored in the IoT system for government safety supervision of smart gas information.

The collection volume refers to an amount of data to be collected from the candidate gas supervision data. The collection volume may include collection time, collection duration, or the like. The collection frequency refers to a count of times the candidate gas supervision data is collected per unit time. The company management platform may determine the collection volume and collection frequency based on the preset supervision level, according to a second preset rule. The second preset rule includes the correspondence between different preset supervision levels and different collection volumes and collection frequencies. The second preset rule may be determined based on historical data or prior experience.

In 260, a feedback result may be obtained and a level adjustment instruction and a collection update instruction may be generated from the government safety supervision management platform based on the government safety supervision sensing network platform.

The feedback result refers to feedback data from the government safety management platform on the verification data and the verification result reported by the company management platform. For example, the feedback result may include a suggestion for strengthening the supervision level of gas supervision region A, or the like. The government safety management platform may provide feedback results on the preset supervision levels for different gas device object platforms and gas user object platforms in different gas supervision regions as determined by a gas company.

In some embodiments, the feedback result may be determined in a variety of ways based on the verification data and the verification result. For example, the feedback result may be determined manually by management personnel of the government safety management platform.

The level adjustment instruction refers to an instruction used to adjust the preset supervision level. The level adjustment instruction may be generated based on the feedback result. The government safety management platform may adjust, based on the feedback result, preset supervision level(s) of at least one gas device object platform and/or gas user object platform associated with the feedback result, for example, by increasing or decreasing the preset supervision level.

In some embodiments, the government safety management platform may send the level adjustment instruction sequentially via the government safety supervision sensing network platform, the gas company management platform, and the company sensing platform to at least one gas device object platform and gas user object platform. The above object platforms adjust the preset supervision level based on the level adjustment instruction.

The collection update instruction is an instruction used to update the collection volume. In some embodiments, the collection update instruction may be generated in response to the level adjustment instruction. Based on the adjusted preset supervision level, the corresponding collection volume is determined, and the collection update instruction is generated. The company management platform may update the collection volume of the candidate gas supervision data for a device such as a gas facility, a terminal, etc. More descriptions of the devices such as the gas facility and the terminal may be found in FIG. 1 and the relevant descriptions thereof.

In some embodiments, the government safety management platform may send the collection update instruction sequentially via the government safety supervision sensing network platform, the gas company management platform, and the company sensing platform to at least one gas device object platform and gas user object platform. The above object platforms adjust the collection volume based on the collection update instruction.

By regulation gas usage through the method for government safety supervision of the smart gas information, analysis and smart verification of gas supervision data are achieved, and the corresponding supervision level and data collection requirement can be determined. The method can significantly save human and material resources, effectively manage the gas supervision data, dynamically adjust the supervision level of the IoT system for government safety supervision of the smart gas information based on the gas supervision data in a targeted manner, improve the reliability of supervision, ensure the effectiveness of gas supervision data management, meet the requirements of government safety regulatory departments, and prevent gas failures.

FIG. 3 is a flowchart of an exemplary process of determining a grade division result as according to some embodiments of the present disclosure. As shown in FIG. 3, process 300 includes the following operations.

In 310, a categorical division and a regional division may be performed on gas supervision data based on a data source, a data content, and a division requirement. More descriptions of the data source, the data content, the categorical division, and the regional division may be found in FIG. 2 and the related descriptions thereof.

The division requirement refers to a preset rule regarding the categorical division and/or the regional division of the gas supervision data. For example, the division requirement may be a requirement that the smallest sub-region within region A be designated as a neighborhood or a street. In some embodiments, the government safety management platform may determine the division requirement based on an administrative region, a type of gas facility, a construction and planning program for a gas-related project, or the like. The administrative region, the type of gas facility, the construction and planning program for the gas-related project, or the like may be obtained from the Internet. The company management platform may obtain the division requirement from the government safety management platform based on the government safety sensing platform. By imposing restrictions on the division of the gas supervision data based on the division requirement, it is possible to prevent further subdivision of key regions and avoid data redundancy.

In some embodiments, the company management platform may, based on the division requirement, further divide a result of a categorical division or a regional division that is performed based on the data source, the data content, etc., to obtain a categorical division result or a regional division result. More descriptions of the categorical division result, the regional division result, and the categorical division or regional division based on the data source, the data content, or the like, may be found in the relevant descriptions of FIG. 2.

In some embodiments, the company management platform may determine a size of a category for the categorical division and a size of a region for the regional division based on an abnormal frequency in the gas supervision data.

The abnormal frequency refers to the frequency and count of occurrences of abnormal data in the gas supervision data within a preset time period. In some embodiments, the abnormal frequency may be obtained based on historical data. For example, the company management platform may determine the abnormal frequency corresponding to a specified piece of gas supervision data based on the count of occurrences of abnormal data in the gas supervision data in a past week. More descriptions of the abnormal data may be found in FIG. 2 and the related descriptions thereof.

In some embodiments, the company management platform may predetermine an original size of a category of the categorical division and an original size of a region of the regional division based on the administrative region, the type of gas facility, the construction and planning program of the gas-related project, or the like. The company management platform may adjust the original size of the category of the categorical division and the original size of the region of the regional division based on the abnormal frequency in the gas supervision data. The adjustment of the original size of the category of the categorical division and the original size of the region of the regional division includes merging or splitting categories and regions.

In some embodiments, a scale of the merging or splitting is related to the abnormal frequency. For example, the lower the abnormal frequency, the larger the scale of the merging. The higher the abnormal frequency, the smaller the categories and regions after the splitting. For example, if the abnormal frequency of the gas supervision data in a region exceeds an abnormal frequency threshold during a preset time period, the company management platform may divide the region into at least 2 sub-regions.

In some embodiments, the company management platform may periodically adjust the size of the category of the categorical division and the size of the region of the regional division based on the abnormal frequency in the gas supervision data.

By taking into account the abnormal frequency of the gas supervision data when determining the categorical division and the regional division, the accuracy of subsequent grade division can be improved.

In 320, a grade division may be performed on the gas supervision data based on the categorical division result, the regional division result, an occurrence time, and a data content.

More about the occurrence time, the data content, and the grade division may be found in FIG. 2 and the related descriptions thereof.

In some embodiments, the company management platform may perform the grade division on the gas supervision data based on the categorical division result, the regional division result, the occurrence time, and the data content in various ways. For example, if a type of gas supervision data or gas supervision data of a region is more important, the type of gas supervision data or the gas supervision data of the region corresponds to a higher grade. As another example, if the occurrence time a piece of gas supervision data is closer to a current time, or if the gas failure in the data content of the gas supervision data is severe, the gas supervision data corresponds to a higher grade. In some embodiments, the company management platform may perform the grade division using a grading model, more of which may be found in FIG. 4.

In 330, a preset transmission rate may be adjusted based on a grade division result. More descriptions of the grade division result and the preset transmission rate may be found in FIG. 2 and the related descriptions thereof.

In some embodiments, the company management platform may adjust the preset transmission rate based on the grade division result. In some embodiments, the company management platform may determine the preset transmission rate by querying an eighth preset table based on the grade division result. The eighth preset table may include a correspondence between the preset transmission rate and the grade division result. The eighth preset table may be determined based on historical data or prior experience. In some embodiments, the preset transmission rate may be positively correlated with the grade of the gas supervision data after the grade division is performed, i.e., the higher the grade of the gas supervision data, the faster the preset transmission rate.

The company management platform may adjust the preset transmission rate of communication device(s) of at least one company sensing platform based on the grade division result. The communication device(s) transmits the gas supervision data based on the adjusted preset transmission rate.

By performing the categorical division and regional division on the gas supervision data based on the data source of the gas supervision data, and further performing the grade division on the gas supervision data, the company management platform can selectively prioritize the transmission and processing of more critical gas supervision data that may lead to significant consequences, thereby enhancing data processing efficiency.

FIG. 4 is a schematic diagram of an exemplary grading model according to some embodiments of the present disclosure.

In some embodiments, the company management platform may determine, using a grading model 460, a grade division result 470 based on gas supervision data 410, a categorical division result 420, a regional division result 430, an occurrence time 440, and a data content 450, and determine an activation frequency the grading model 460.

More descriptions of the gas supervision data, the categorical division result, the regional division result, the occurrence time and the data content, and the grade division result may be found in FIG. 2 and FIG. 3 and the related descriptions thereof.

The activation frequency refers to a count of times the company management platform initiates the grade model for grade division per unit time. The activation frequency of the grading model may vary during different time periods, and the company management platform may adjust the activation frequency according to actual situations.

In some embodiments, the company management platform may determine the activation frequency based on a historical grade division result and an abnormal frequency of the gas supervision data.

In historical grade division results, a proportion of gas supervision data whose last grade division result exceeding a preset high-grade threshold may correlate positively with the activation frequency. The higher the proportion of the gas supervision data whose last grade division result exceeding the preset high-grade threshold, the higher the activation frequency of the grading model. The preset high-grade threshold refers to a minimum value of the grade division result when the grade division result of the gas supervision data is determined to be high-grade, and the preset high-grade threshold may be set manually. More descriptions of the abnormal frequency may be found in FIG. 3 and the related descriptions thereof.

The abnormal frequency of the gas supervision data is positively correlated with the activation frequency. The higher the abnormal frequency is, the greater the risk is, and the higher the activation frequency of the grading model is.

In some embodiments, the activation frequency is correlated with relevant facility data. If there is malfunction or maintenance data of other public facilities in the relevant facility data, it indicates that the related public facilities may have an impact on a gas system, and the activation frequency may be appropriately increased. More descriptions of the relevant facility data may be found in FIG. 2 and the related descriptions thereof.

In some embodiments, the company management platform may determine a baseline activation frequency based on the abnormal frequency and the relevant facility data and adjust the baseline activation frequency based on different gas demand relationships to determine the activation frequency. For example, the company management platform may determine the baseline activation frequency by using the following formula (4):

$$f = \frac{a \times {p}_{h}}{{p}_{0}} + γ \qquad ( 4 )$$

Wherein, f denotes the baseline activation frequency, a denotes an abnormal coefficient, pₕ denotes a proportion of actual gas supervision data grade division results exceeding the preset high-grade threshold, p₀ denotes a proportion of preset gas supervision data grade division results exceeding the preset high-grade threshold, and γ denotes a relevant facility factor.

The abnormal coefficient characterizes an impact of the abnormal frequency of the gas supervision data on the baseline activation frequency. In some embodiments, the anomaly factor may be a ratio of the abnormal frequency to a preset abnormal frequency. The preset abnormal frequency is a preset standard abnormal frequency that may be determined based on historical data. For example, the preset abnormal frequency may be an average of historical abnormal frequencies in the historical data.

The relevant facility factor characterizes an impact of the relevant facility data on the baseline activation frequency. In some embodiments, the relevant facility factor may be determined based on a count of failures and a count of maintenance warnings of relevant public facilities within a current activation cycle of the grading model, along with a preset correction coefficient. The current activation cycle refers to the time period from a previous activation of the grading model to the current activation of the grading model. The preset correction coefficient is manually determined. The relevant facility factor may be a ratio of a sum of the count of the failures and the count of the maintenance warnings of the relevant public facility within the activation cycle of the grading model to the preset correction coefficient.

In some embodiments, the company management platform may adjust the baseline activation frequency based on a gas usage pattern to determine the activation frequency. A count of activations corresponding to a peak gas usage period and a count of activations corresponding to an off-peak gas usage period may be different. For example, the preset activation frequency is 1 time/24 h. When the baseline activation frequency (e.g. 4 times/24 h) is greater than the preset activation frequency, the count of activations during the peak gas usage period may be set to three times the count of activations during the off-peak gas usage period.

In some embodiments, the company management platform may adjust the baseline activation frequency based on weekdays to determine the activation frequency. The activation frequency corresponding to weekdays and holidays may be different. For example, if the baseline activation frequency (e.g. 0.86 times/24 h) does not exceed the preset activation frequency, and assuming a fixed total count of baseline activations within a week (e.g. 6 times/week), the company management platform may set the count of activations during holidays to 3 and the count of activations during weekdays to 3.

The grading model refers to a model used to determine the grade division result. The grading model may be a machine learning model, such as a neural network model, or the like.

In some embodiments, an input of the grading model may include the gas supervision data, the occurrence time and data content of the gas supervision data, the categorical division result, and the regional division result, and an output of the grading model may include the grade division result of the gas supervision data.

In some embodiments, the company management platform may train the grading model based on division training samples with division labels. Each set of division training samples includes sample gas supervision data, a sample occurrence time, a sample data content, a sample categorical division result, and a sample regional division result. A first label and a first training sample may be obtained based on historical data. The company management platform may input a plurality of division training samples with division labels into an initial grading model, construct a loss function through a result of the division labels and the initial grading model, and iteratively update parameter(s) of the initial grading model based on the loss function. When the loss function of the initial grading model meets a preset condition, model training is completed, and a trained grading model is obtained. The preset condition may be that the loss function converges, a count of iterations reaches a threshold, or the like.

The division labels include sample grade division results corresponding to the division training samples. In some embodiments, the company management platform may annotate the divisional labels based on a possible impact of the division training samples in combination with an actual impact generated by historical gas supervision data. The divisional labels may be annotated manually. The possible impact of the division training samples may include an impact on warning efficiency, an impact on supervision efficiency, or the like. For example, if it is determined, based on historical data, that a set of division training samples may result in a large impact and a warning cannot be issued in a timely manner. In such cases, through manual determination, the set of division training samples may be annotated as the highest level, such as Grade 1.

In some embodiments, the grading model is obtained by training based on grading training samples with grading labels. The grading training samples include at least one training set, and based on a count of division changes of the sample regional division results over a preset time period, a training sample size corresponding to a training set of the regional division results is determined. The grading training samples may be divided into at least one training set in accordance with the regional division results.

The count of division changes refers to a count of times a region is divided during a preset time period. For example, the count of division changes may be the count of times regions are merged and split. More descriptions of the merging and splitting of regions may be found in FIG. 3 and the related descriptions thereof. The count of division changes may include a preset range of counts. The preset range of counts refers to a range of preset count of division changes. In some embodiments, the company management platform may divide the grading training samples into a plurality of training sets based on a lower limit and an upper limit of the preset range of counts. For example, the company management platform may divide the grading training samples into three training sets, with one training set of grading training samples having a count of division changes less than the lower limit of the preset range of counts, one training set of grading training samples having a count of division changes within the preset range of counts, and one training set of grading training samples have a count of division changes greater than the upper limit of the preset range of counts. The company management platform may determine the training sets based on the categorical division result and the abnormal frequency in a similar manner as described above.

The training sample size refers to the data volume in the training sets of grading training samples. In some embodiments, the company management platform may determine the training sample size based on the count of division changes. The count of division changes is positively correlated with the training sample size. For example, the company management platform may determine the training sample size by using the following formula (5):

$$β = n \times {β}_{0} \qquad ( 5 )$$

Wherein, β denotes the training sample size, n denotes the count of division changes, and β₀ denotes a preset data volume, which may be predetermined manually.

The grading labels may be obtained based on historical data. The grading labels may be obtained in a similar way as the divisional labels and may be specifically referred to in the relevant description of the division labels.

In some embodiments, the company management platform may train the initial grading model by using the at least one training set alternately based on a preset training order. The preset training order may be predetermined manually. The process of using the at least one training set is similar to the process of training the grading model using the division training samples, as may be referred to in the related description above.

Based on the sample categorical division results and the sample regional division results, at least one training sets are determined. Training the initial grading model based on the at least one training sets sequentially can avoid data redundancy and improve the training efficiency of the grading model.

Determining the grade division result based on the trained grading model allows for rapid dynamic grade division of a large amount of gas supervision data, saving manpower and resources, and improving grading efficiency.

Since the gas supervision data at different times and in different regions may often be correlated, frequent activation of the grading model may result in interruption and segmentation of the gas supervision data, thus reducing the accuracy of data processing. Some embodiments of the present disclosure take into account the characteristics of gas supervision data from different time periods and, combined with historical grade division results, reasonably determine the activation frequency of the grading model, thereby ensuring the reliability of data grading.

Some embodiments of the present disclosure provide a non-transitory computer-readable storage medium storing one or more set of computer instructions. When reading the one or more set of computer instructions in the storage medium, a computer implements the method for government safety supervision of the smart gas information as described in any of the embodiments of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for government safety supervision of smart gas information, comprising:
obtaining gas supervision data from a gas device object platform and/or a gas user object platform based on a gas company sensing network platform, wherein the gas supervision data includes an occurrence time, a data source, and a data content, and the gas company sensing network platform transmits the gas supervision data at a preset transmission rate based on a communication device;
determining a division result based on the gas supervision data;
determining verification data based on the gas supervision data and the division result, sending the verification data to a government safety supervision management platform based on a government safety supervision sensing network platform, and receiving a verification result feedbacked from the government safety supervision management platform;
determining a preset supervision level for the gas device object platform and/or the gas user object platform based on the verification result and determining a collection volume and a collection frequency for candidate gas supervision data based on the preset supervision level; and
obtaining a feedback result and generating a level adjustment instruction and a collection update instruction from the government safety supervision management platform based on the government safety supervision sensing network platform, wherein the feedback result is determined based on the verification data and the verification result, the level adjustment instruction and the collection update instruction are generated based on the feedback result, the level adjustment instruction is configured for an adjustment of the preset supervision level, and the collection update instruction is configured for an update of the collection volume.

2. The method of claim 1, further comprising:
performing a categorical division and a regional division on the gas supervision data based on the data source, the data content, and a division requirement;
performing a grade division on the gas supervision data based on a categorical division result, a regional division result, the occurrence time, and the data content; and
adjusting the preset transmission rate based on a grade division result.

3. The method of claim 2, wherein a size of a category for the categorical division and a size of a region for the regional division are determined based on an abnormal frequency of the gas supervision data.

4. The method of claim 2, wherein the grade division includes:
determining the grade division result through a grading model based on the gas supervision data, the categorical division result, the regional division result, the occurrence time, and the data content, and determining an activation frequency of the grading model, wherein the grading model is a machine learning model.

5. The method of claim 4, wherein the grading model is obtained by training based on a grading training sample with a grading label, the grading training sample includes at least one training set, the at least one training set is determined based on a sample categorical division result and a sample regional division result, and a training sample size of a training set corresponding to the sample regional division result is determine based on a count of division changes in a preset time period for the sample regional division result.

6. The method of claim 1, further comprising:
determining the verification data based on a dynamic grading result of the gas supervision data and relevant facility data; and
determining a sorting sequence based on the verification data.

7. The method of claim 6, wherein the sorting sequence is adjusted in response to determining that the dynamic grading result satisfies a preset adjustment condition.

8. The method of claim 6, further comprising:
determining the preset supervision level based on the verification result and a historical supervision level; and
determining the collection volume based on the preset supervision level.

9. The method of claim 8, further comprising:
determining the preset supervision level based on weighted data of the dynamic grading result.

10. An Internet of things (IoT) system for government safety supervision of smart gas information, comprising a government safety supervision management platform, a government safety supervision sensing network platform, a government safety supervision object platform, a gas company sensing network platform, a gas device object platform, and a gas user object platform, wherein,
the government safety supervision object platform includes a gas company management platform, the gas company management platform being configured to:
obtain gas supervision data from a gas device object platform and/or a gas user object platform based on a gas company sensing network platform, wherein the gas supervision data includes an occurrence time, a data source, and a data content, and the gas company sensing network platform transmits the gas supervision data at a preset transmission rate based on a communication device;
determine a division result based on the gas supervision data;
determine verification data based on the gas supervision data and the division result, send the verification data to the government safety supervision management platform based on the government safety supervision sensing network platform, and receive a verification result feedbacked from the government safety supervision management platform;
determine a preset supervision level for the gas device object platform and/or the gas user object platform based on the verification result and determine a collection volume and a collection frequency for candidate gas supervision data based on the preset supervision level; and
obtain a feedback result and generate a level adjustment instruction and a collection update instruction from the government safety supervision management platform based on the government safety supervision sensing network platform, wherein the feedback result is determined based on the verification data and the verification result, the level adjustment instruction and the collection update instruction are generated based on the feedback result, the level adjustment instruction is configured for an adjustment of the preset supervision level, and the collection update instruction is configured for an update of the collection volume.

11. The system of claim 10, wherein the gas company management platform is further configured to:
perform a categorical division and a regional division on the gas supervision data based on the data source, the data content, and a division requirement;
perform a grade division on the gas supervision data based on a categorical division result, a regional division result, the occurrence time, and the data content; and
adjust the preset transmission rate based on a grade division result.

12. The system of claim 11, wherein a size of a category for the categorical division and a size of a region for the regional division are determined based on an abnormal frequency of the gas supervision data.

13. The system of claim 11, wherein the gas company management platform is further configured to:
determine the grade division result through a grading model based on the gas supervision data, the categorical division result, the regional division result, the occurrence time, and the data content, and determine an activation frequency of the grading model, wherein the grading model is a machine learning model.

14. The system of claim 13, wherein the grading model is obtained by training based on a grading training sample with a grading label, the grading training sample includes at least one training set, the at least one training set is determined based on a sample categorical division result and a sample regional division result, and a training sample size of a training set corresponding to the sample regional division result is determined based on a count of division changes in a preset time period for the sample regional division result.

15. The system of claim 10, wherein the gas company management platform is further configured to:
determine the verification data based on a dynamic grading result of the gas supervision data and relevant facility data; and
determine a sorting sequence based on the verification data and send the verification data and the sorting sequence to the government safety supervision management platform, the government safety supervision management platform being configured on at least one set of servers and caching media for caching the verification data and checking the verification data against the sorting sequence.

16. The system of claim 15, wherein the sorting sequence is adjusted in response to determining that the dynamic grading result satisfies a preset adjustment condition.

17. The system of claim 15, wherein the gas company management platform is further configured to:
determine the preset supervision level based on the verification result and a historical supervision level; and
determine the collection volume based on the preset supervision level.

18. The system of claim 17, wherein the gas company management platform is further configured to:
determine the preset supervision level based on weighted data from the dynamic grading result.

19. A non-transitory computer-readable storage medium storing one or more set of computer instructions, wherein when reading the one or more set of computer instructions in the storage medium, a computer implements the method of claim 1.
